(19) United States
(12) Patent Application Publication
(10) Pub. No.: US 2016/0012827 A1
(43) Pub. Date: Jan. 14, 2016

(54) SMART SPEAKERPHONE

(71) Applicant: Cambridge Silicon Radio Limited, Cambridge (GB)

(72) Inventors: Rogerio Guedes Alves, Macomb, MI (US); Tao Yu, Rochester Hills, MI (US)

(73) Assignee: Cambridge Silicon Radio Limited, Cambridge (GB)

(21) Appl. No.: 14/328,574

(22) Filed: Jul. 10, 2014

(51) Int. Cl. G10L 21/02; G10L 21/10; G10K 11/178; G10L 21/0208; H04R 1/40; H04R 3/00

(52) U.S. Cl. CPC G10L 21/0202; H04R 1/406; H04R 3/005; G10K 11/178; G10L 21/0208; G10L 21/10; H04R 2410/01; H04R 2430/21

(57) ABSTRACT

Embodiments are directed towards a speaker/microphone system. Each microphone in a microphone array generate an audio signal based on sound in a physical space. The microphone array may be arranged to logically define the physical space into a plurality of regions that have a status of active or inactive. An output signal may be generated from the audio signals, such that directional noise reduction is performed on audio signals associated with inactive regions and speech enhancement is performed on audio signals associated with active regions. A region's current status may be modified to its opposite status based on a request provided by a user. The request may be triggered by an activator or a spoken word/phrase provided by the user. An indication may be provided to the user regarding each current status for each region. The indication may also represent a quality of audio signals associated with active regions.

### TECHNICAL FIELD

The present invention relates generally to directional noise cancellation and speech enhancement, and more particularly, but not exclusively, to tracking user speech across various listening regions of a speakerphone.

### BACKGROUND

Today, many people use “hands-free” telecommunication systems to talk with one another. These systems often utilize mobile phones, a remote loudspeaker, and a remote microphone to achieve hands-free operation, and may generally be referred to as speakerphones. Speakerphones can introduce—to a user—the freedom of having a phone call in different environments. In noisy environments, however, these systems may not operate at a level that is satisfactory to a user. For example, the variation in power of user speech in the speakerphone microphone may generate a different signal-to-noise ratio (SNR) depending on the environment and/or the distance between the user and the microphone. Low SNR can make it difficult to detect or distinguish the user speech signal from the noise signals. Additionally, a user may change locations during a phone call, which can impact the usefulness of directional noise cancelling algorithms. Thus, it is with respect to these considerations and others that the invention has been made.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 is a system diagram of environment in which embodiments of the invention may be implemented;

FIG. 2 shows an embodiment of a network computer that may be included in a system such as that shown in FIG. 1;

FIG. 3 shows an embodiment of a speaker/microphone system that may be included in a system such as that shown in FIG. 1

FIG. 4 illustrates an example use-case environment and scenario for employing embodiments described herein;

FIGS. 5A-5C illustrate example alternative use-case environments for employing embodiments described herein;

FIG. 6 illustrates a block diagram generally showing a system that may be employed in accordance with embodiments described herein;

FIG. 7 illustrates a logical flow diagram of an environment generally showing an embodiment of an overview process for tracking audio listening regions; and

FIG. 8 illustrates a logical flow diagram of an environment generally showing an embodiment of a process for tracking audio listening regions and providing user feedback.

### DETAILED DESCRIPTION

Various embodiments are described more fully hereinafter with reference to the accompanying drawings, which form a part hereof, and which show, by way of illustration, specific embodiments by which the invention may be practiced. The embodiments may, however, be embodied in many different forms and should not be construed as limited to the embodiments set forth herein; rather, these embodiments are provided so that this disclosure will be thorough and complete, and will fully convey the scope of the embodiments to those skilled in the art. Among other things, the various embodiments may be methods, systems, media, or devices. Accordingly, the various embodiments may be entirely hardware embodiments, entirely software embodiments, or embodiments combining software and hardware aspects. The following detailed description should, therefore, not be limiting.

Throughout the specification and claims, the following terms take the meanings explicitly associated herein, unless the context clearly dictates otherwise. The term “herein” refers to the specification, claims, and drawings associated with the current application. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

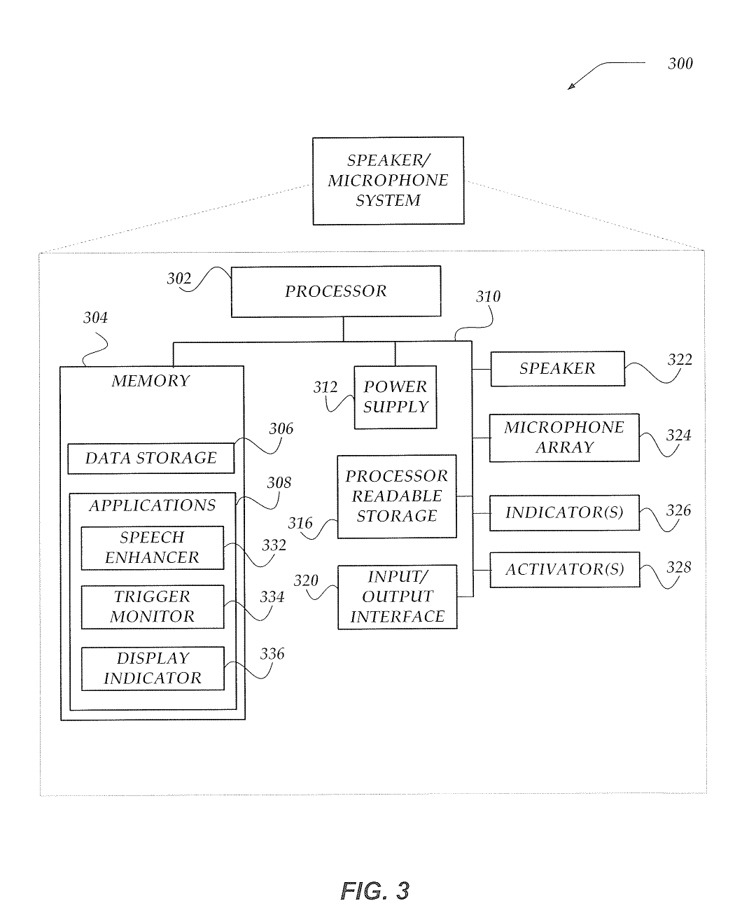

As used herein, the term “speaker/microphone system” may refer to a system or device that may be employed to enable “hands free” telecommunications. One example embodiment of a speaker/microphone system is illustrated in FIG. 3. Briefly, however, a speaker/microphone system may include one or more speakers, a microphone array, and at least one indicator. In some embodiments, a speaker/microphone system may also include one or more activators.

As used herein, the term “microphone array” may refer to a plurality of microphones of a speaker/microphone system. Each microphone in the microphone array may be positioned, configured, and/or arranged to conceptually/logically divide a physical space adjacent to the speaker/microphone system into a pre-determined number of regions. In various embodiments, one or more microphone may correspond or be associated with a region.

As used herein, the term “region” or “listening region” may refer to an area of focus for one or more microphones of the microphone array, where the one or more microphones may be enabled to provide directional listening to pick up audio signals from a given direction (e.g., active regions), while minimizing or ignoring signals from other directions/regions (e.g., inactive regions). In various embodiments, multiple beams may be formed for different regions, which may operate like ears focusing on a specific direction. As used herein, the term “active region” may refer to a region where those audio signals associated with that region are denoted as user speech signals and may be enhanced in an output signal. As used herein, the term “inactive region” may refer to a region where those audio signals associated with that region are denoted as noise signals and may be suppressed, reduced, or otherwise canceled in the output signal. Although the term inactive is used herein, microphones associated with inactive regions continue to sense sound and generate audio signals (e.g., for use in detecting spoken trigger words and/or phrases).

As used herein, the term “trigger” may refer to a user input that requests a change in a status of one or more regions. The trigger may be input by physical means (e.g., by engaging an activator), voice commands (e.g., a user speaking or saying a trigger word or phrase), or the like. As used herein, the term “activator” may refer to a mechanism for receiving input from a user to modify a status (e.g., active to inactive or inactive to active) of one or more regions. Examples of activators may include, but are not limited to, buttons; switches; display buttons, icons, or other graphical or audio user interfaces; gestures or other user-movement-sensing technology; or the like.

As used herein, the term indicator may refer to a representation of a region's status and/or a quality of a signal associated with an active region, which may be provided to a user through various graphical or audio user interfaces. In various embodiments, indicators may be a visual representation, such as, for example, light emitting diodes (LEDs), display screens, or the like. In other embodiments, indicators may include audio indicators or prompts, such as, for example, “region one is now active,” “poor signal quality, please move closer to the microphone,” or the like. In some embodiments, each region may have a corresponding indicator to present the region's status, e.g., active or inactive, to a user. In other embodiments, each region may have a corresponding indicator to present the quality of signals (e.g., a signal to noise ratio (SNR)) of that region to user. In some embodiments, the region-status indicator and the quality-of-signal indicator may be the same indicator or separate indicators. Various different colors, different light intensities, different flashing schemes/patterns, or the like can be used to indicate different region statuses and/or signal qualities.

The following briefly describes embodiments of the invention in order to provide a basic understanding of some aspects of the invention. This brief description is not intended as an extensive overview. It is not intended to identify key or critical elements, or to delineate or otherwise narrow the scope. Its purpose is merely to present some concepts in a simplified form as a prelude to the more detailed description that is presented later.

Briefly stated, various embodiments are directed to a speaker/microphone system that provides directional speech enhancement and noise reduction. The system may include a speaker for outputting sound/audio to a user. The system may also include a microphone array that includes a plurality of microphones. Each of a plurality of microphones may be employed to generate at least one audio signal based on sound sensed in a physical space relative to the system and/or user. The plurality of microphones may be arranged to logically define the physical space into a plurality of listening regions, and wherein each status for each listening region is logically defined as active or inactive. An output signal may be generated from the audio signals, such that directional noise reduction may be performed on each audio signal associated with each inactive listening region and speech enhancement may be performed on each audio signal associated with each active listening region.

A current status of at least one of the plurality of listening regions may be modified based on a request to change the current status to its opposite status. In various embodiments, the modification to the current status of one listening region may trigger modification of a current status of at least one other listening region to its opposite status. In some embodiments, at least the audio signals associated with each inactive listening region may be monitored for a spoken word that is operative to trigger the request to change the current status. In at least one of various embodiments, at least the at least one audio signals associated with each inactive listening region may be monitored for a spoken word that triggers the request, wherein a first monitored spoken word triggers activation of an inactive listening region and simultaneously triggers inactivation of an active listening region, and wherein a second monitored spoken word triggers activation of the inactive listening region and the current status of each other listening region remains unchanged. In other embodiments, the request to change status may be triggered by an action from the user on at least one of a plurality of activators, wherein each activator corresponds to at least one different listening region.

An indication may be provided to a user regarding each current status for each of the plurality of listening regions. In some embodiments, another indication may be provided to the user regarding a quality of the audio signals associated with each active listening region. In various embodiments, a graphical user interface may be provided to the user, which may include an activator and an indicator for each of the plurality of listening regions, wherein each activator enables the user to activate or inactivate the current status for at least a corresponding listening region and each indicator represents an audio signal quality associated with each active listening region.

### Illustrative Operating Environment

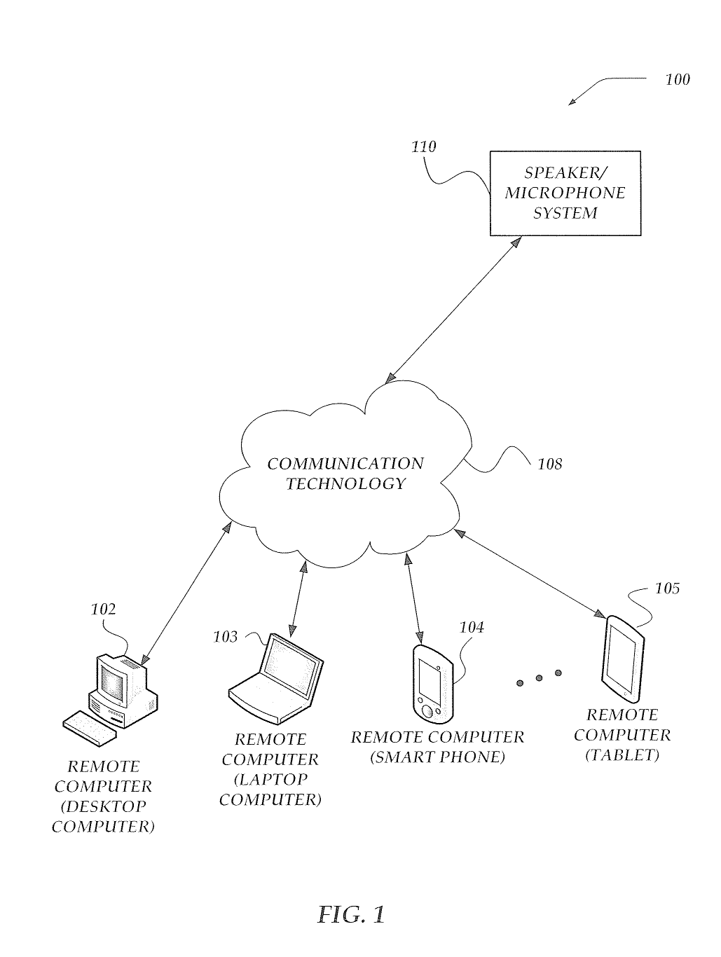

FIG. 1 shows components of one embodiment of an environment in which various embodiments of the invention may be practiced. Not all of the components may be required to practice the various embodiments, and variations in the arrangement and type of the components may be made without departing from the spirit or scope of the invention. As shown, system 100 of FIG. 1 may include speaker/microphone system 110 remote computers 102-105, and communication technology 108.

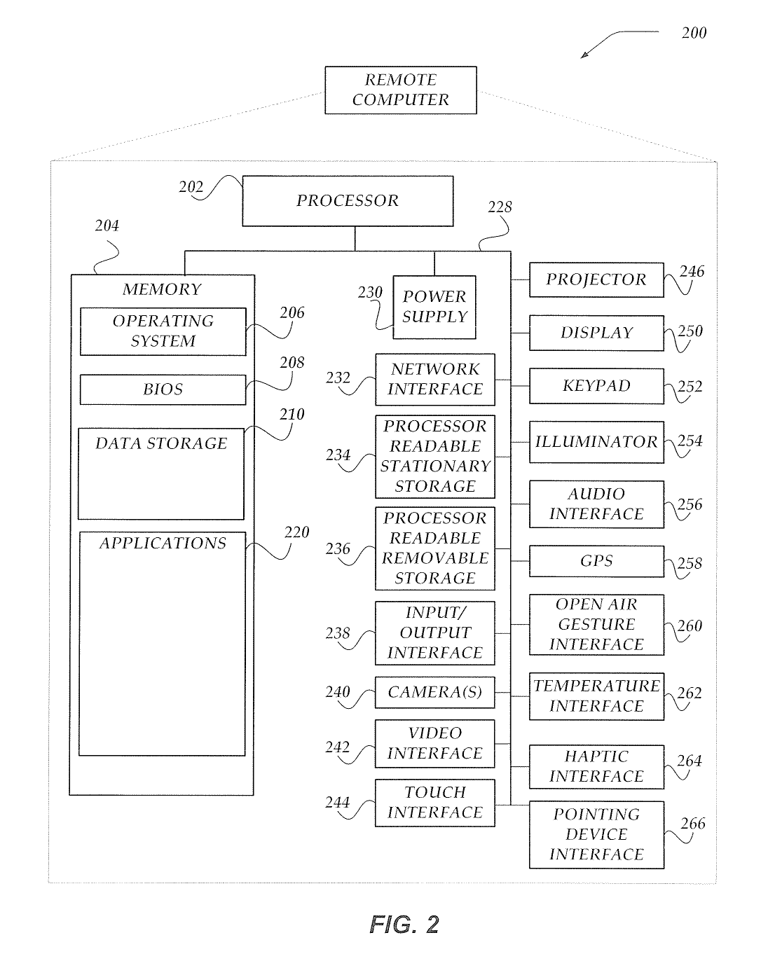

At least one embodiment of remote computers 102-105 is described in more detail below in conjunction with computer 200 of FIG. 2. Briefly, in some embodiments, remote computers 102-105 may be configured to communicate with speaker/microphone system 110 to enable hands-free telecommunication with other devices, while providing listening region tracking with user feedback, as described herein.

In some embodiments, at least some of remote computers 102-105 may operate over a wired and/or wireless network (e.g., communication technology 108) to communicate with other computing devices or speaker/microphone system 110. Generally, remote computers 102-105 may include computing devices capable of communicating over a network to send and/or receive information, perform various online and/or offline activities, or the like. It should be recognized that embodiments described herein are not constrained by the number or type of remote computers employed, and more or fewer remote computers—and/or types of remote computers—than what is illustrated in FIG. 1 may be employed.

Devices that may operate as remote computers 102-105 may include various computing devices that typically connect to a network or other computing device using a wired and/or wireless communications medium. Remote computers may include portable and/or non-portable computers. In some embodiments, remote computers may include client computers, server computers, or the like. Examples of remote computers 102-105 may include, but are not limited to, desktop computers (e.g., remote computer 102), personal computers, multiprocessor systems, microprocessor-based or programmable electronic devices, network PCs, laptop computers (e.g., remote computer 103), smart phones (e.g., remote computer 104), tablet computers (e.g., remote computer 105), cellular telephones, display pagers, radio frequency (RF) devices, infrared (IR) devices, Personal Digital Assistants (PDAs), handheld computers, wearable computing devices, entertainment/home media systems (e.g., televisions, gaming consoles, audio equipment, or the like), household devices (e.g., thermostats, refrigerators, home security systems, or the like), multimedia navigation systems, automotive communications and entertainment systems, integrated devices combining functionality of one or more of the preceding devices, or the like. As such, remote computers 102-105 may include computers with a wide range of capabilities and features.

Remote computers 102-105 may access and/or employ various computing applications to enable users of remote computers to perform various online and/or offline activities. Such activities may include, but are not limited to, generating documents, gathering/monitoring data, capturing/manipulating images, managing media, managing financial information, playing games, managing personal information, browsing the Internet, or the like. In some embodiments, remote computers 102-105 may be enabled to connect to a network through a browser, or other web-based application.

Remote computers 102-105 may further be configured to provide information that identifies the remote computer. Such identifying information may include, but is not limited to, a type, capability, configuration, name, or the like, of the remote computer. In at least one embodiment, a remote computer may uniquely identify itself through any of a variety of mechanisms, such as an Internet Protocol (IP) address, phone number, Mobile Identification Number (MIN), media access control (MAC) address, electronic serial number (ESN), or other device identifier.

At least one embodiment of speaker/microphone system 110 is described in more detail below in conjunction with computer 300 of FIG. 3. Briefly, in some embodiments, speaker/microphone system 110 may be configured to communicate with one or more of remote computers 102-105 to provide remote, hands-free telecommunication with others, while enabling listening region tracking with user feedback. Speaker/microphone system 110 may generally include a microphone array, speaker, one or more indicators, and one or more activators. Examples of speaker/microphone system 110 may include, but are not limited to, Bluetooth soundbar or speaker with phone call support, karaoke machines with internal microphone, home theater systems, mobile phones, or the like.

Remote computers 102-105 may communicate with speaker/microphone system 110 via communication technology 108. In various embodiments, communication technology 108 may be a wired technology, such as, but not limited to, a cable with a jack for connecting to an audio input/output port on remote devices 102-105 (such a jack may include, but is not limited to a typical headphone jack, a USB connection, or other suitable computer connector). In other embodiments, communication technology 108 may be a wireless communication technology, which may include virtually any wireless technology for communicating with a remote device, such as, but not limited to, Bluetooth, Wi-Fi, or the like.

In some embodiments, communication technology 108 may be a network configured to couple network computers with other computing devices, including remote computers 102-105, speaker/microphone system 110, or the like. In various embodiments, information communicated between devices may include various kinds of information, including, but not limited to, processor-readable instructions, remote requests, server responses, program modules, applications, raw data, control data, system information (e.g., log files), video data, voice data, image data, text data, structured/unstructured data, or the like. In some embodiments, this information may be communicated between devices using one or more technologies and/or network protocols.

In some embodiments, such a network may include various wired networks, wireless networks, or any combination thereof. In various embodiments, the network may be enabled to employ various forms of communication technology, topology, computer-readable media, or the like, for communicating information from one electronic device to another. For example, the network can include—in addition to the Internet—LANs, WANs, Personal Area Networks (PANs), Campus Area Networks (CANs), Metropolitan Area Networks (MANs), direct communication connections (such as through a universal serial bus (USB) port), or the like, or any combination thereof.

In various embodiments, communication links within and/or between networks may include, but are not limited to, twisted wire pair, optical fibers, open air lasers, coaxial cable, plain old telephone service (POTS), wave guides, acoustics, full or fractional dedicated digital lines (such as T1, T2, T3, or T4), E-carriers, Integrated Services Digital Networks (ISDNs), Digital Subscriber Lines (DSLs), wireless links (including satellite links), or other links and/or carrier mechanisms known to those skilled in the art. Moreover, communication links may further employ any of a variety of digital signaling technologies, including without limit, for example, DS-0, DS-1, DS-2, DS-3, DS-4, OC-3, OC-12, OC-48, or the like. In some embodiments, a router (or other intermediate network device) may act as a link between various networks—including those based on different architectures and/or protocols—to enable information to be transferred from one network to another. In other embodiments, remote computers and/or other related electronic devices could be connected to a network via a modem and temporary telephone link. In essence, the network may include any communication technology by which information may travel between computing devices.

The network may, in some embodiments, include various wireless networks, which may be configured to couple various portable network devices, remote computers, wired networks, other wireless networks, or the like. Wireless networks may include any of a variety of sub-networks that may further overlay stand-alone ad-hoc networks, or the like, to provide an infrastructure-oriented connection for at least remote computers 103-105. Such sub-networks may include mesh networks, Wireless LAN (WLAN) networks, cellular networks, or the like. In at least one of the various embodiments, the system may include more than one wireless network.

The network may employ a plurality of wired and/or wireless communication protocols and/or technologies. Examples of various generations (e.g., third (3G), fourth (4G), or fifth (5G)) of communication protocols and/or technologies that may be employed by the network may include, but are not limited to, Global System for Mobile communication (GSM), General Packet Radio Services (GPRS), Enhanced Data GSM Environment (EDGE), Code Division Multiple Access (CDMA), Wideband Code Division Multiple Access (W-CDMA), Code Division Multiple Access 2000 (CDMA2000), High Speed Downlink Packet Access (HSPDA), Long Term Evolution (LTE), Universal Mobile Telecommunications System (UMTS), Evolution-Data Optimized (Ev-DO), Worldwide Interoperability for Microwave Access (WiMax), time division multiple access (TDMA), Orthogonal frequency-division multiplexing (OFDM), ultra wide band (UWB), Wireless Application Protocol (WAP), user datagram protocol (UDP), transmission control protocol/Internet protocol (TCP/IP), any portion of the Open Systems Interconnection (OSI) model protocols, session initiated protocol/real-time transport protocol (SIP/RTP), short message service (SMS), multimedia messaging service (MMS), or any of a variety of other communication protocols and/or technologies. In essence, the network may include communication technologies by which information may travel between remote computers 102-105, speaker/microphone system 110, other computing devices not illustrated, other networks, or the like.

In various embodiments, at least a portion of the network may be arranged as an autonomous system of nodes, links, paths, terminals, gateways, routers, switches, firewalls, load balancers, forwarders, repeaters, optical-electrical converters, or the like, which may be connected by various communication links. These autonomous systems may be configured to self organize based on current operating conditions and/or rule-based policies, such that the network topology of the network may be modified.

### Illustrative Network Computer

FIG. 2 shows one embodiment of remote computer 200 that may include many more or less components than those shown. Remote computer 200 may represent, for example, at least one embodiment of remote computers 102-105 shown in FIG. 1.

Remote computer 200 may include processor 202 in communication with memory 204 via bus 228. Remote computer 200 may also include power supply 230, network interface 232, processor-readable stationary storage device 234, processor-readable removable storage device 236, input/output interface 238, camera(s) 240, video interface 242, touch interface 244, projector 246, display 250, keypad 252, illuminator 254, audio interface 256, global positioning systems (GPS) receiver 258, open air gesture interface 260, temperature interface 262, haptic interface 264, and pointing device interface 266. Remote computer 200 may optionally communicate with a base station (not shown), or directly with another computer. And in one embodiment, although not shown, a gyroscope, accelerometer, or other technology (not illustrated) may be employed within remote computer 200 to measuring and/or maintaining an orientation of remote computer 200.

Power supply 230 may provide power to remote computer 200. A rechargeable or non-rechargeable battery may be used to provide power. The power may also be provided by an external power source, such as an AC adapter or a powered clocking cradle that supplements and/or recharges the battery.

Network interface 232 includes circuitry for coupling remote computer 200 to one or more networks, and is constructed for use with one or more communication protocols and technologies including, but not limited to, protocols and technologies that implement any portion of the OSI model, GSM, CDMA, time division multiple access (TDMA), UDP, TCP/IP, SMS, MMS, GPRS, WAP, UWB, WiMax, SIP/RTP, GPRS, EDGE, WCDMA, UMTS, OFDM, CDMA2000, EV-DO, HSDPA, or any of a variety of other wireless communication protocols. Network interface 232 is sometimes known as a transceiver, transceiving device, or network interface card (NIC).

Audio interface 256 may be arranged to produce and receive audio signals such as the sound of a human voice. For example, audio interface 256 may be coupled to a speaker and microphone (not shown) to enable telecommunication with others and/or generate an audio acknowledgement for some action. A microphone in audio interface 256 can also be used for input to or control of remote computer 200, e.g., using voice recognition, detecting touch based on sound, and the like. In some embodiments, audio interface 256 may be operative to communicate with speaker/microphone system 300 of FIG. 3.

Display 250 may be a liquid crystal display (LCD), gas plasma, electronic ink, light emitting diode (LED), Organic LED (OLED) or any other type of light reflective or light transmissive display that can be used with a computer. Display 250 may also include a touch interface 244 arranged to receive input from an object such as a stylus or a digit from a human hand, and may use resistive, capacitive, surface acoustic wave (SAW), infrared, radar, or other technologies to sense touch and/or gestures.

Projector 246 may be a remote handheld projector or an integrated projector that is capable of projecting an image on a remote wall or any other reflective object such as a remote screen.

Video interface 242 may be arranged to capture video images, such as a still photo, a video segment, an infrared video, or the like. For example, video interface 242 may be coupled to a digital video camera, a web-camera, or the like. Video interface 242 may comprise a lens, an image sensor, and other electronics. Image sensors may include a complementary metal-oxide-semiconductor (CMOS) integrated circuit, charge-coupled device (CCD), or any other integrated circuit for sensing light.

Keypad 252 may comprise any input device arranged to receive input from a user. For example, keypad 252 may include a push button numeric dial, or a keyboard. Keypad 252 may also include command buttons that are associated with selecting and sending images.

Illuminator 254 may provide a status indication and/or provide light. Illuminator 254 may remain active for specific periods of time or in response to events. For example, when illuminator 254 is active, it may backlight the buttons on keypad 252 and stay on while the mobile computer is powered. Also, illuminator 254 may backlight these buttons in various patterns when particular actions are performed, such as dialing another mobile computer. Illuminator 254 may also cause light sources positioned within a transparent or translucent case of the mobile computer to illuminate in response to actions.

Remote computer 200 may also comprise input/output interface 238 for communicating with external peripheral devices or other computers such as other mobile computers and network computers. The peripheral devices may include a remote speaker/microphone system (e.g., device 300 of FIG. 3), headphones, display screen glasses, remote speaker system, or the like. Input/output interface 238 can utilize one or more technologies, such as Universal Serial Bus (USB), Infrared, WiFi, WiMax, Bluetooth™, wired technologies, or the like.

Elaptic interface 264 may he arranged to provide tactile feedback to a user of a mobile computer. For example, the haptic interface 264 may be employed to vibrate remote computer 200 in a particular way when another user of a computer is calling. Temperature interface 262 may be used to provide a temperature measurement input and/or a temperature changing output to a user of remote computer 200. Open air gesture interface 260 may sense physical gestures of a user of remote computer 200, for example, by using single or stereo video cameras, radar, a gyroscopic sensor inside a computer held or worn by the user, or the like. Camera 240 may be used to track physical eve movements of a user of remote computer 200.

GPS transceiver 258 can determine the physical coordinates of remote computer 200 on the surface of the Earth, which typically outputs a location as latitude and longitude values. GPS transceiver 258 can also employ other geo-positioning mechanisms, including, but not limited to, triangulation, assisted GPS (AGPS), Enhanced Observed Time Difference (E-OTD), Cell Identifier (CI), Service Area Identifier (SAI), Enhanced Timing Advance (ETA), Base Station Subsystem (BSS), or the like, to further determine the physical location of remote computer 200 on the surface of the Earth. It is understood that under different conditions, GPS transceiver 258 can determine a physical location for remote computer 200. In at least one embodiment, however, remote computer 200 may, through other components, provide other information that may be employed to determine a physical location of the mobile computer, including for example, a Media Access Control (MAC) address, IP address, and the like.

Human interface components can be peripheral devices that are physically separate from remote computer 200, allowing for remote input and/or output to remote computer 200. For example, information routed as described here through human interface components such as display 250 or keyboard 252 can instead be routed through network interface 232 to appropriate human interface components located remotely. Examples of human interface peripheral components that may be remote include, but are not limited to, audio devices, pointing devices, keypads, displays, cameras, projectors, and the like. These peripheral components may communicate over a Pico Network such as Bluetooth™, Zigbee™ and the like. One non-limiting example of a mobile computer with such peripheral human interface components is a wearable computer, which might include a remote pico projector along with one or more cameras that remotely communicate with a separately located mobile computer to sense a user's gestures toward portions of an image projected by the pico projector onto a reflected surface such as a wall or the user's hand.

A mobile computer may include a browser application that is configured to receive and to send web pages, web-based messages, graphics, text, multimedia, and the like. The mobile computer's browser application may employ virtually any programming language, including a wireless application protocol messages (WAP), and the like. In at least one embodiment, the browser application is enabled to employ Handheld Device Markup Language (HDML), Wireless Markup Language (WML), WMLScript, JavaScript, Standard Generalized Markup Language (SGML), HyperText Markup Language (HTML), eXtensible Markup Language (XML), HTML5, and the like.

Memory 204 may include RAM, ROM, and/or other types of memory. Memory 204 illustrates an example of computer-readable storage media (devices) for storage of information such as computer-readable instructions, data structures, program modules, or other data. Memory 204 may store BIOS 208 for controlling low-level operation of remote computer 200. The memory may also store operating system 206 for controlling the operation of remote computer 200. It will be appreciated that this component may include a general-purpose operating system (e.g., a version of Microsoft Corporation's Windows or Windows Phone™, Apple Corporation's OSX™ or iOS™, Google Corporation's Android, UNIX, LINUX™, or the like). In other embodiments, operating system 206 may be a custom or otherwise specialized operating system. The operating system functionality may be extended by one or more libraries, modules, plug-ins, or the like.

Memory 204 may further include one or more data storage 210, which can be utilized by remote computer 200 to store, among other things, applications 220 and/or other data. For example, data storage 210 may also be employed to store information that describes various capabilities of remote computer 200. The information may then be provided to another device or computer based on any of a variety of events, including being sent as part of a header during a communication, sent upon request, or the like. Data storage 210 may also be employed to store social networking information including address books, buddy lists, aliases, user profile information, or the like. Data storage 210 may further include program code, data, algorithms, and the like, for use by a processor, such as processor 202 to execute and perform actions. In one embodiment, at least some of data storage 210 might also be stored on another component of remote computer 200, including, but not limited to, non-transitory processor-readable removable storage device 236, processor-readable stationary storage device 234, or even external to the mobile computer.

Applications 220 may include computer executable instructions which, when executed by remote computer 200, transmit, receive, and/or otherwise process instructions and data. Examples of application programs include, but are not limited to, calendars, search programs, email client applications, IM applications, SMS applications. Voice Over Internet Protocol (VOIP) applications, contact managers, task managers, transcoders, database programs, word processing programs, security applications, spreadsheet programs, games, search programs, and so forth.

### Illustrative Speaker/Microphone System

FIG. 3 shows one embodiment of speaker/microphone system 300 that may include many more or less components than those shown. System 300 may represent, for example, at least one embodiment of speaker/microphone system 110 shown in FIG. 1. In various embodiments, system 300 may be remotely located (e.g., physically separate from) to another device, such as remote computer 200 of FIG. 2.

Although speaker/microphone system 300 is illustrated as a single device—such as a remote speaker system with hands-free telecommunication capability (e.g., includes a speaker, a microphone, and Bluetooth capability to enable a user to telecommunicate with others)—embodiments are not so limited. For example, in some other embodiments, speaker/microphone system 300 may be employed as multiple separate devices, such as a remote speaker system and a separate remote microphone that together may be operative to enable hands-free telecommunication. Although embodiments are primarily described as a smart phone utilizing a remote speaker with microphone system, embodiments are not so limited. Rather embodiments described herein may be employed in other systems, such as, but not limited to sounds bars with phone call capability, home theater systems with phone call capability, mobile phones with speaker phone capability, automobile devices with hands-free phone call capability, or the like.

In any event, system 300 may include processor 302 in communication with memory 304 via bus 310. System 300 may also include power supply 312, input/output interface 320, speaker 322, microphone array 324, indicator(s) 326, activator(s) 328, processor-readable storage device 316. In some embodiments, processor 302 (in conjunction with memory 304) may be employed as a digital signal processor within system 300. So, in some embodiments, system 300 may include speaker 322, microphone array 324, and a chip (noting that such a system may include other components, such as a power supply, various interfaces, other circuitry, or the like), where the chip is operative with circuitry, logic, or other components capable of employing embodiments described herein.

Power supply 312 may provide power to system 300. A rechargeable or non-rechargeable battery may be used to provide power. The power may also be provided by an external power source, such as an AC adapter that supplements and/or recharges the battery.

Speaker 322 may be a loudspeaker or other device operative to convert electrical signals into audible sound. In some embodiments, speaker 322 may include a single loudspeaker, while in other embodiments, speaker 322 may include a plurality of loudspeakers (e.g., if system 300 is implemented as a soundbar).

Microphone array 324 may include a plurality of microphones that is operative to capture audible sound and convert them into electrical signals. In various embodiments, the microphone array may be physically positioned/configured/arranged on system 300 to logically define a physical space relative to system 300 into a plurality of listening regions, where each status for each listening region is logically defined as active or inactive;

In at least one of various embodiments, speaker 322 in combination with microphone array 324 may enable telecommunication with users of other devices.

Indicator(s) 326 may include one or more indicators to provide feedback to a user. In various embodiments, indicator 326 may indicate a status of each of a plurality of regions (generated by microphone array 324), such as which regions are active regions (e.g., listening regions that provide speech enhancement) and which regions are inactive regions (e.g., noise canceling regions). In some embodiments, indicator 326 may be a display screen that may show the different regions and their corresponding status. In other embodiments, indicator 326 may be an audio prompt that may include a verbal indication of a regions status. In yet other embodiments, indicator 326 may include a separate LED, or other identifier, for each region, which may indicate the corresponding region's status (e.g., active or inactive). In at least one of various embodiments, a green LED may indicate that its corresponding region is active and a red LED may indicate that its corresponding region is inactive. In other embodiments, blinking LEDs may indicate an active region where solidly-lit LEDs or non-lit LEDs may be inactive regions. However, embodiments are not so limited, and other indicators or types of indicators may be employed to indicate a status of each of a plurality of regions.

In various embodiments, indicator(s) 326 may provide feedback to a user depicting a quality of signals received through active listening regions. In at least one of various embodiments, the quality of signals may be based on the signal to noise ratio (SNR). In various embodiments, if the SNR falls below a predetermined threshold, then the indicator for the active region may change to demonstrate the change or degradation in the received signal. For example, an active region with an SNR above a first threshold may be represented to a user by a green LED. If the SNR for the active region falls below the first threshold, then this degradation of the signal may be represented to the user by a yellow LED (so the indicator may change from green to yellow). More or less thresholds, colors, blinking sequences, or the like, or indicators may be employed to represent a plurality of different qualities of signals received by an active region. In another example, it the indicator is a display screen, such a screen may have changing colors or words to indicate changes in the signal for an active region. So, in some embodiments, the display indicator may say which regions are active and which are inactive, and of the active regions, the quality of the signal received within that region. In some embodiments, the display indicator (or an audio prompt/indicator) may provide instructions to the user for ways to improve the quality of the signal, such as, but not limited to, “speak louder,” “move closer to speaker,” “move to a different region” (either active or inactive, noting that the user may have to active the inactive region (e.g., by stating the trigger word or activating an activator 328 that corresponds to that region), or the like, or a combination thereof.

Activator(s) 328 may include one or more activators to activate/inactivate (or deactivate) a corresponding region. In various embodiments, activator(s) 328 may include a plurality of buttons or switches that each correspond to a different region. In other embodiments, a touch screen may enable a user to select a region for activation or inactivation (which may be a same or different screen than indicator 326). In various embodiments, an activator may be employed to active or inactive all regions. In some embodiments, activator(s) 328 may be optional, such as when activation/inactivation of regions may be triggered by voice recognition of a trigger or activation word/phrase (e.g., determined by trigger monitor 334).

System 300 may also comprise input/output interface 320 for communicating with other devices or other computers, such as remote computer 200 of FIG. 2, or other mobile/network computers. Input/output interface 320 can utilize one or more technologies, such as Universal Serial Bus (USB), Infrared, WiFi, WiMax, Bluetooth™, wired technologies, or the like.

Although not illustrated, system 300 may also include a network interface, which may operative to couple system 300 to one or more networks, and may be constructed for use with one or more communication protocols and technologies including, but not limited to, protocols and technologies that implement any portion of the OSI model, GSM, CDMA, time division multiple access (TDMA), UDP, TCP/IP, SMS, MMS, GPRS, WAP, UWB, WiMax, SIP/RTP, GPRS, EDGE, WCDMA, LTE, UMTS, OFDM, CDMA2000, EV-DO, HSDPA, or any of a variety of other wireless communication protocols. Such a network interface is sometimes known as a transceiver, transceiving device, or network interface card (NIC).

Memory 304 may include RAM, ROM, and/or other types of memory. Memory 304 illustrates an example of computer-readable storage media (devices) for storage of information such as computer-readable instructions, data structures, program modules, or other data. Memory 304 may further include one or more data storage 306. In some embodiments, data storage 306 may store, among other things, applications 308. In various embodiments, data storage 306 may include program code, data, algorithms, and the like, for use by a processor, such as processor 302 to execute and perform actions. In one embodiment, at least some of data storage 306 might also be stored on another component of system 300, including, but not limited to, non-transitory processor-readable storage 316.

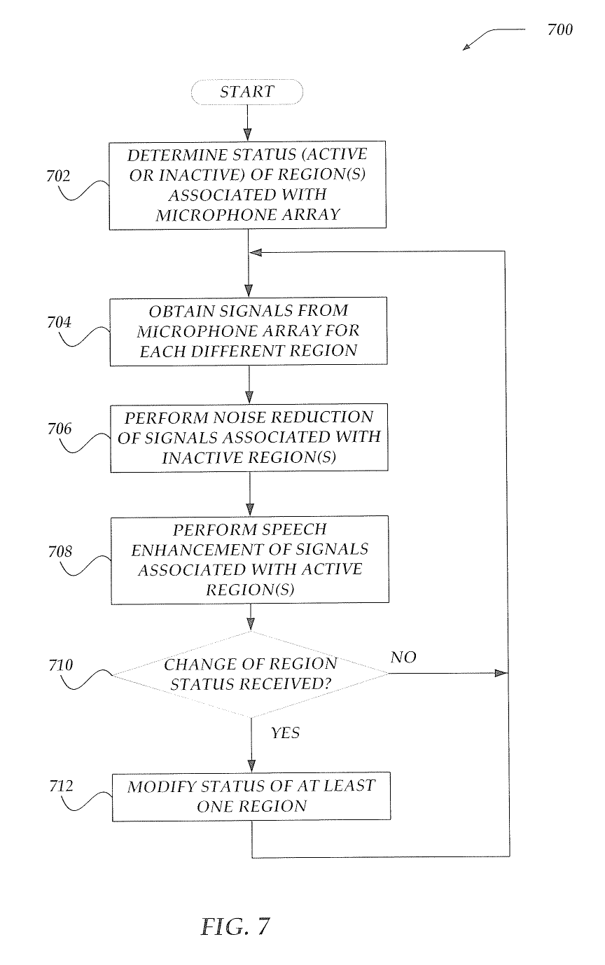

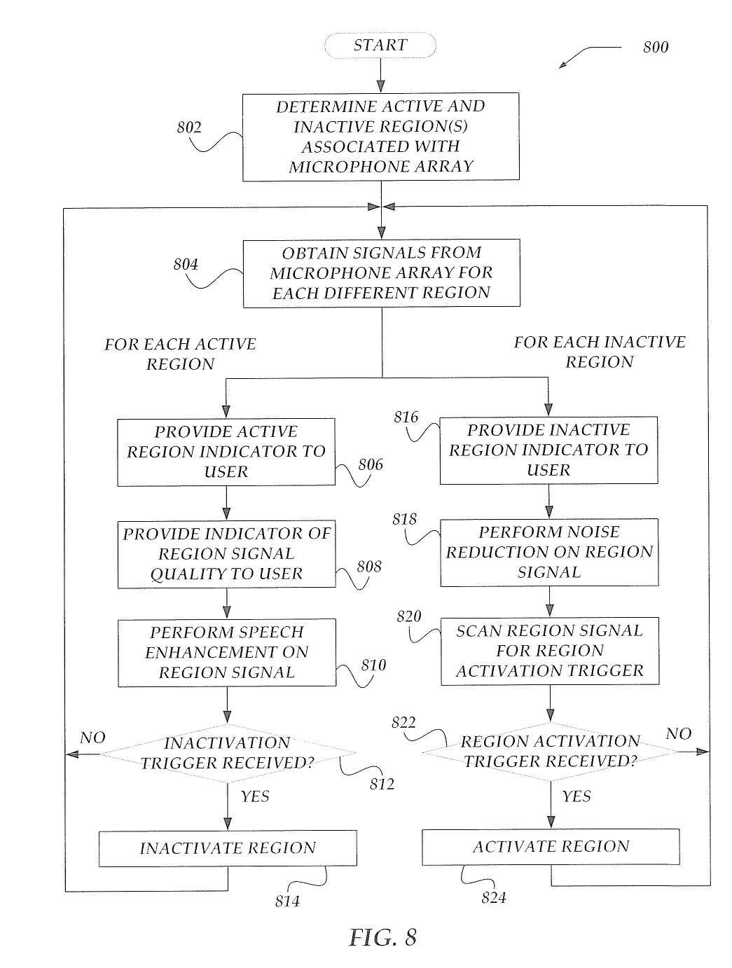

Applications 308 may include speech enhancer 332, trigger monitor 334, and display indicator 336. In various embodiments, these application may be enabled to employ embodiments described herein and/or to employ processes, or parts of processes, similar to those described in conjunction with FIGS. 7 and 8.

Speech enhancer 332 may be operative to provide various algorithms, methods, and/or mechanisms for enhancing speech received through microphone array 324. In various embodiments, speech enhancer 332 may employ various beam selections and combination techniques, beamforming techniques, noise cancellation techniques (for noise received through inactive regions), noise enhancement techniques (for signals received through active regions, or the like, or a combination thereof. Various beamforming techniques may be employed, such as but not limited to, U.S. patent application Ser. No. 13/842,911, entitled “METHOD, APPARATUS, AND MANUFACTURE FOR BEAMFORMING WITH FIXED WEIGHTS AND ADAPTIVE SELECTION OR RESYNTHESIS,” U.S. patent application Ser. No. 13/843,254, entitled “METHOD, APPARATUS, AND MANUFACTURE FOR TWO-MICROPHONE ARRAY SPEECH ENHANCEMENT FOR AN AUTOMOTIVE ENVIRONMENT;” and patent application Ser. No. 13/666,101, entitled “ADAPTIVE MICROPHONE BEAMFORMING,” which are herein incorporated by reference.

Trigger monitor 334 may be operative to manage activation/inactivation (i.e., status) of the plurality of regions. In some embodiments, trigger monitor 334 may be in communication with activator(s) 328 to determine the status of each region or to determine if a region's status has changed. In other embodiments, trigger monitor 334 may monitor signals received through microphone array 324 to detect trigger words/phrases that may be associated with a status change of a region. In some embodiments, a trigger may impact a single region, such as activating an inactive region when a trigger word is detected in a signal associated with the inactive region. In other embodiments, a trigger may impact a plurality of regions, such as inactivating a plurality of regions, activating one or more regions while inactivating one or more other regions, or the like. In at least one of the various embodiments, a trigger may active or inactive all regions (e.g., an “all on” trigger word/phrase or activator).

Display indicator 336 may be operative to manage indicator(s) 326 with various information regarding each region's status, the quality of signals associated with active regions, or the like.

In some embodiments, hardware components, software components, or a combination thereof of system 300 may employ processes, or part of processes, similar to those described in conjunction with FIGS. 7 and 8.

### Illustrative Use Case Environments

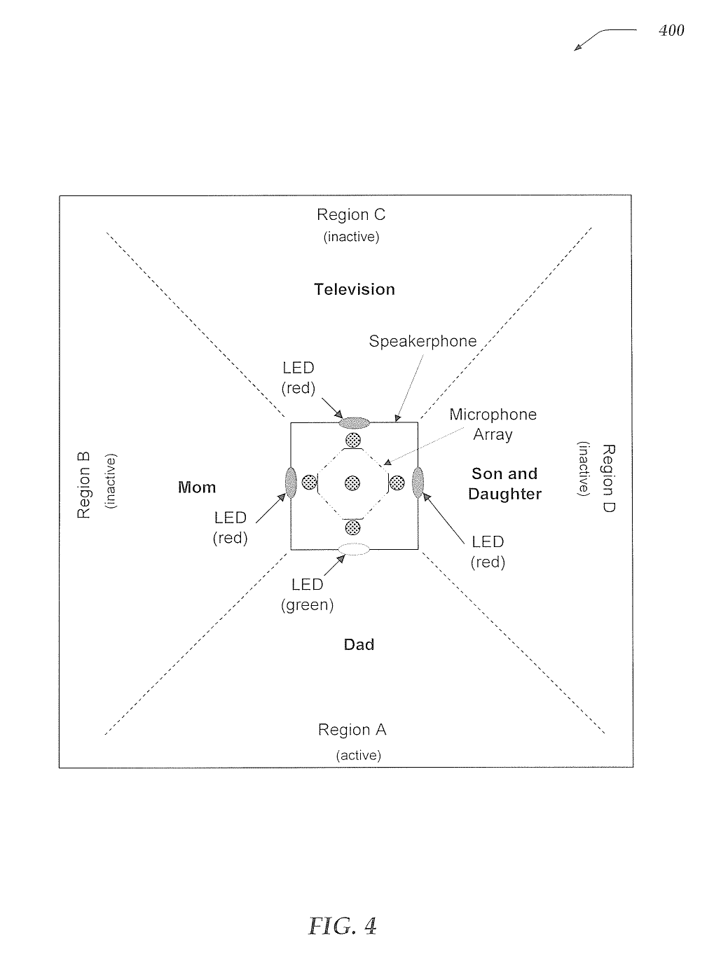

Clarity of embodiments described herein may be improved by first describing an example scenario where embodiments may be employed. Accordingly, FIG. 4 illustrates an example use-case environment and scenario for employing embodiments described herein.

Environment 400 may include a speakerphone (e.g., speaker/microphone system 300 of FIG. 3) positioned in the center of a room. The speakerphone may be configured to have four separate regions, regions A, B, C, and D (although more or less regions may also be employed). Imagine that a family of four people (Dad, Mom, Son and Daughter) are sitting around the speakerphone, such that Mom is in region B, Dad is in Region A, and son and daughter are in region D (and a television is in region C). As illustrated, region A may be active and may provide Dad with an active region indicator in the form of a green LED. Region B, C, and D may be inactive, which may be represented by the red LED inactive-region indicators. These initial statuses may be based on defaults setting for when a phone call in initiated.

Assume Dad is using the speakerphone to talk with Grandma, but the rest of the family (Mom, Son and Daughter) do not want be part of the current conversation. For example, Mom may be watching a video on her smartphone and the kids may be talking about school. In this situation only Dad's voice is desired on the phone call. Accordingly, various beamforming algorithm may be employed to enhance signals associated with region A—thus enhancing Dad's voice—while reducing, suppressing, or otherwise cancelling the noise/inference signals associated with regions B, C, and D.

Assume the following changes in the scenario:
Minute 0.00—Dad initiates a call to Grandma from region A. The speakerphone should suppress noise coming from regions B, C and D.
Minute 2:00—The kids want to say “Hi” to Grandma after Dad tell his “great” news to her. The speakerphone should change the active region from A to D, and it should suppress noise coming from regions A, B and C.
Minute 3:00—Dad wants to reengage his conversation with Grandma. The speakerphone should change the active region from D to A, and suppress noise coming from regions B, C and D.
Minute 5:00—Mom wants to tell Grandma more information about the “great” news. The speakerphone should change the active region from A to B, and suppress noise coming from regions A, C and D.
Minute 6:30—Dad wants to join Mom in their conversation with Grandma. The speakerphone should change make region A active while maintaining region B as active, and suppress noise coming from regions C and D.
Minute 8:30—Dad goes from region A to region C while Grandma is talking and now he wants finalize the call, without Mom, from region C. The speakerphone should change the active listening region from A to C, and suppress noise coming from regions A, B and D.

By employing embodiments described herein, the following actions may be performed to adjust each region's status accordingly. (Noting that in this example, changes in at least one region's status may be triggered by trigger words/phrases that may be detected/identified (e.g., by employing speech/voice recognition algorithms) in audio signals associated with at least inactive regions. However, embodiments are not so limited and other triggers, such as activators 328 of FIG. 3 may also or alternatively be employed to trigger changes in one or more region's status.)
Minute 0.00—Dad initiates a call to Grandma from region A. The speakerphone may have default settings such that region A is active and regions B, C, and D are inactive, such that signals associated with region A may be enhanced and signals associated with regions B, C, and D may be suppressed.
Minute 2:00—The kids want to say “Hi” to Grandma after Dad tell his “great” news to her. The kids may say the trigger word while in region D, which may be picked up by one or more microphones associated with region D. Accordingly, region D may become active and region A may become inactive, such that signals associated with region D may be enhanced and signals associated with region A (along with regions B and C) may be suppressed.
Minute 3:00—Dad wants to reengage his conversation with Grandma. Dad may say the trigger word while in region A, which may be picked up by one or more microphones associated with region A. Accordingly, region A may become active and region D may become inactive, such that signals associated with region A may be enhanced and signals associated with region D (along with regions B and C) may be suppressed.
Minute 5:00—Mom wants to tell Grandma more information about the “great” news. Mom may say the trigger word while in region B, which may be picked up by one or more microphones associated with region B. Accordingly, region B may become active and region A may become inactive, such that signals associated with region B may be enhanced and signals associated with region A (along with regions C and D) may be suppressed.
Minute 6:30—Dad wants to join Mom in their conversation with Grandma. Dad may say a different trigger word while in region A, which may be picked up by microphones associated with region A. Accordingly, region A may become active and region B may remain active, such that signals associated with regions A and B may be enhanced and signals associated with regions C and D may be suppressed.
Minute 8:30—Dad goes from region A to region C while Grandma is talking and now he wants finalize the call, without Mom, from region C. Dad may say the first trigger word while in region C, which may be picked up by microphones associated with region C. Accordingly, region C may become active and regions A and B may become inactive, such that signals associated with region C may be enhanced and signals associated with regions A, B, and D may be suppressed.

It should be noted that as a region's status changes from active to inactive, the green LED of the region may change to red, and as a region's status changes from inactive to active, the red LED of the region may change to green. Embodiments, are not so limited and other indicators may be employed, as described herein. Similarly, indicator may also provide a user with a visual representation of a quality of signals associated with an active region (or how loud the noise signals are in inactive regions).

It should also be noted that other triggers may be employed to change a region's status. For example, at minute 5:00 mom may push a button (or other activator) on the speakerphone to activate region B, which may automatically inactivate region B. Or, in other embodiments, mom may push a button on the speakerphone to activate region B but also push a different button to inactivate region A.

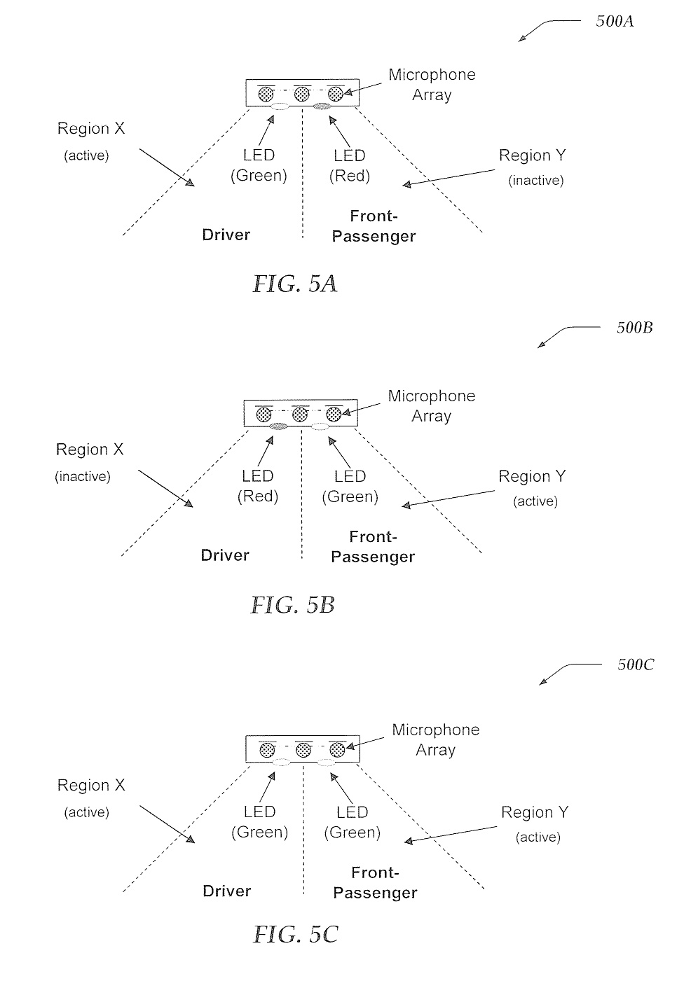

FIGS. 5A-5C illustrate example alternative use-case environments for employing embodiments described herein. In one non-limiting, non-exhaustive example, systems 500A, 500B and 500C of FIGS. 5A-5C, respectively, may represent a speaker/microphone system (e.g., speaker/microphone system 300 of FIG. 3) that may be employed in an automobile setting. System 500A may include a microphone array, which may logically separate the interior (also referred to as the driver/operator compartment) of an automobile into two listening regions, region X and region Y. In this example, region X may be directed towards a driver (or driver's seat area) and region Y may be directed towards a front passenger (or front passenger's seat area). So in some embodiments, system 500A may be positioned in front of and between the driver and the front passenger (where the driver and the front passenger are in a side-by-side seating arrangement).

However, embodiments are not so limited and system 500A may be in other positions of the automobile and/or may logically separate the interior into more listening regions (e.g., one region per passenger seat). For example, in other embodiments, system 500A may be positioned in the roof of the automobile relatively, centrally located (e.g., near a dome light of an automobile) and may logically divide the interior into five listening regions, one for the driver, one for the front passenger, one for the rear driver-side passenger, one for the rear passenger-side passenger, and one for the rear middle passenger. In other embodiments, multiple speaker/microphone system may be employed, such as one system for the driver and front passenger and another system for the back scat passengers. In some embodiments, these systems may operate independent of each other. In other embodiments, these systems may cooperate with each other to provide additional speech enhancement of active regions and noise cancellation/reduction of inactive regions between both systems.

For system 500A, assume the driver and passenger are participating in a phone call, a green LED may represent that region X is active and a red LED may represent that region Y is inactive such that speech signals from the driver are enhanced but speech signals from the front passenger are reduced or cancelled out. It should be noted that other indicators described herein (e.g., a display screen) may also be employed. In various embodiments, other noise cancelling algorithms may also be employed to reduce/cancel other environmental noise, such as automobile noise, road noise, audio signals produced from a radio/stereo system, or the like.

By employing embodiments described herein, the front passenger may wish to participate in the phone call. The front passenger may say a trigger word/phrase and/or may employ an activator (e.g., push a button) to change the status of region Y from inactive to active. Upon activation by the front-passenger, region Y may become active and region X may become inactive, which is illustrated by system 500B in FIG. 5B. In some embodiments, the front passenger (or the driver) may have to inactive region X so that both regions are not simultaneously active. In other embodiments, region X may be automatically inactivated upon activation of region Y. As a region's status changes, the LED may also change to represent the changed status.

System 500C in FIG. 5C illustrates the scenario where both region X and region Y are both active. For example, in some embodiments, the front passenger may trigger activation of region Y (from FIG. 5A), which may activate region Y while leaving the status of region X unchanged, such that multiple regions are simultaneously active.

### Example System Diagram

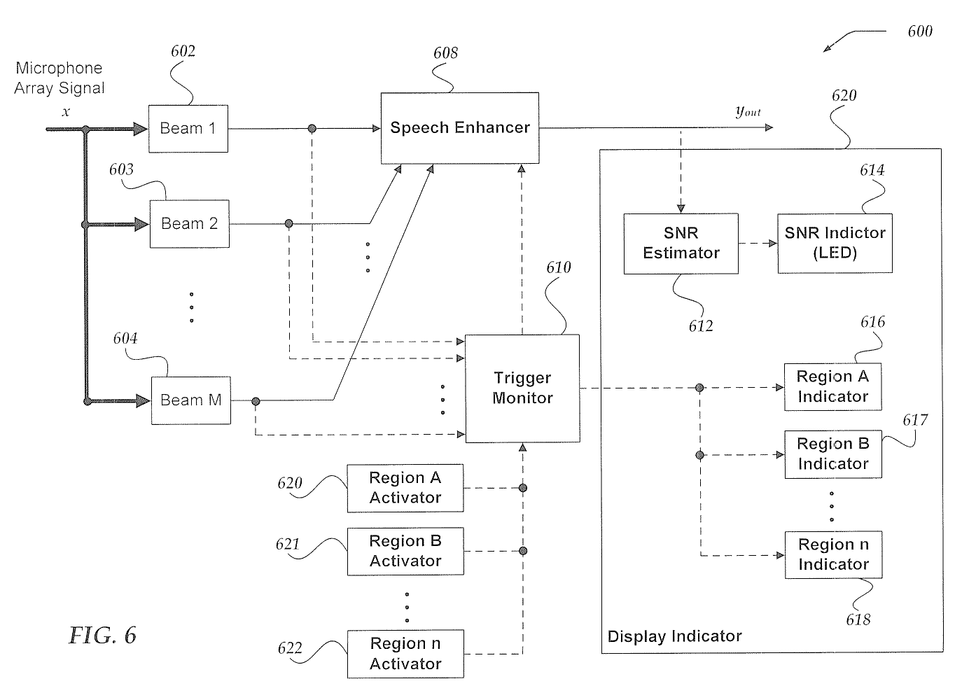

FIG. 6 illustrates a block diagram generally showing a system that may be employed in accordance with embodiments described herein. System 600 may be an embodiment of speaker/microphone system 300 of FIG. 3. In various embodiments, at least speech enhancer 608, trigger monitor 610, and/or display indicator 620 may be employed as logic within a hardware chip (e.g., a digital signal processor, microcontroller, other hardware chips/circuits, or the like). Signal x may be input (e.g., through an input logic) from a microphone array (in various embodiments signal x may include a plurality of signals or beams, e.g., one from each microphone in the array). Signal x may be separated into beams 602-604, where each beam represents a corresponding listening region. It should be noted that beams 602-604 may be based on the number of microphones in the microphone array and the number of listening regions.

Each of beams 602-604 may be input to speech enhancer 608. Speech enhancer 608 may perform various beam selection and combination algorithms—to reduce/cancel noise from inactive regions while enhancing user speech from active regions—dependent on which regions are active and which regions are inactive. In various embodiments, speech enhancer 608 may be an embodiment of speech enhancer 332 of FIG. 3.

In some embodiments, each of beams 602-604 may be also input into trigger monitor 610, such as if changes in a region's status may be triggered by a spoken trigger word and/or phrase. In other embodiments, changes in a region's status may be triggered by region activators 620-622, where each separate activator corresponds to a separate region. In various embodiments, region activators 620-622 may be embodiments of activator(s) 328 of FIG. 3. In some embodiments, both trigger word/phrase and region activators may be employed to trigger changes in one or more region's status.

In some embodiments, trigger monitor 610 may be an embodiment of trigger monitor 334 and may perform various speech and/or voice recognition algorithms to detect trigger words/phrases in beams 602-604. In other embodiments, trigger monitor 610 may accept inputs from region activators 620-622. Based on the inputs and/or the speech recognition, trigger monitor 610 may output each region's active/inactive status to speech enhancer 608. In this way, speech enhancer 608 knows which regions are active and which regions are inactive, and when there are changes in a region's status. Trigger monitor 610 may also output each region's status to region indicators 616-618.

Region indicators 616-618 may be embodiments of indicator(s) 326 of FIG. 3. Region indicators 616-618 may provide a representation of a region's status to a user (e.g., green/red LEDs, a display screen, or the like).

Speech enhancer 608 may output signal yₒᵤₜ from selected one beam or combined several beams, while blocking signal(s) from other beams based on the relationship of the beams with active/inactive regions. Therefore, the unwanted noises of inactive regions may be suppressed and interested speech of active regions may be enhanced. Signal yₒᵤₜ may be sent to another device that is participating in the phone call, and it may also be input to SNR (signal-to-noise ratio) estimator 612.

SNR estimator 612 may determine and/or estimate the SNR based on the output signal. SNR estimator 612 may compare the SNR to one or more threshold values to determine a quality of the speech signals associated with active regions. Based on this comparison, SNR indicator 614 may provide a representation of the signal quality to a user. For example, if the SNR is relatively high (e.g., above a first threshold), then SNR indicator 614 may be a green LED. If the SNR is not high (e.g., below the first threshold, but above a second threshold), then SNR indicator 614 may be a yellow. If the SNR is very low (e.g., below the second threshold), then SNR indicator 614 may be a blue LED. In various embodiments, other indicators may also be employed to represent the signal quality. In some embodiments, SNR indicator 614 may be an embodiment of indicator 326 of FIG. 3. In other embodiments, each region indicator 616 may also include a corresponding SNR indicator 614. In some other embodiments, the functionality of SNR estimator 612 may be employed by speech enhancer 608, such that speech enhancer 608 outputs a SNR indicator signal.

Various functionality of SNR estimator 612, SNR indicator 614 and/or region indicators 616 may be employed by display indicator 620, which may determine and/or manage how each indicator may behave based on the trigger monitor 610 and speech enhancer 608. In various embodiments. display indicator 620 may be an embodiment of display indicator 336 of FIG. 3.

### General Operation

Operation of certain aspects of the invention will now be described with respect to FIGS. 7 and 8. In at least one of various embodiments, at least a portion of processes 700 and 800 described in conjunction with FIGS. 7 and 8, respectively, may be implemented by and/or executed on one or more network computers, such as speaker/microphone system 300 of FIG. 3. Additionally, various embodiments described herein can be implemented in a system such as system 100 of FIG. 1.

FIG. 7 illustrates a logical flow diagram of an environment generally showing an embodiment of an overview process for tracking audio listening regions.

Process 700 may begin, after a start block, at block 702, where a status of each region associated with a microphone array may be determined. In various embodiments, the number of microphones in the microphone array and/or beamforming techniques employed may determine the number of regions. Examples of number of microphones compared to number of regions may include, but is not limited to, five microphones for four regions, such as illustrated in FIG. 4; three microphones for two regions, such as illustrated in FIGS. 5A-5C; two microphones for four regions; or the like.

In various embodiments, each region may have a status of active or inactive. As described herein, an active region may be a region of interest, such that signals received from the active region are employed as the target user speech. In some embodiments, signals received from the active region may be enhanced or otherwise improved. An inactive region may be a noise region or a non-active region, such that signals received from the inactive region are reduced, suppressed, or otherwise cancelled out of the active region signal.

In some embodiments, each region may have a predetermined or default status when the speaker/microphone system is turned on. In one non-limiting, non-exhaustive example each region may be initially inactive. In another example, one region may be active and each other region may be inactive. In some other embodiments, the status of each region may be restored to a previous status that was stored prior to the system being turned off.

In any event, process 700 may proceed to block 704, where signals may be obtained from the microphone array for each different region. In some embodiments, a single obtained signal may correspond to a particular region. In other embodiments, a plurality of the obtained signals may correspond to a particular region. In yet other embodiments, one or more obtained signals may correspond to multiple regions. The signals and their corresponding regions may be dependent on the physical layout or positioning of the microphone array and/or the beamforming techniques employed to provide directional listening.

Process 700 may continue at block 706, where noise reduction of signals associated with inactive region(s) may be performed. Various noise cancelling techniques and/or directional beamforming techniques may be employed to reduce, suppress, or cancel signals associated with inactive regions from an output signal.

Process 700 may proceed next to block 708, where speech enhancement of signals associated with active region(s) may be performed. Various speech or signal enhancement techniques or directional beamforming techniques may be employed to enhance signals associated with active regions for the output signal.

After block 708, process 700 may continue at decision block 710, where a determination may be made whether a request to change a region's status has been received. In various embodiments, a region-status-change request may be received if a user engages a trigger for a region. This trigger may be to change an active region into an inactive region or to change an inactive region to an active region. In some embodiments, multiple regions may change based on a single region-status-change request or multiple region-status-change requests. In various embodiments, the trigger or change request may be based on identification of a trigger word or phrase in a signal (e.g., a signal associated with an inactive region) and/or a user's employment of an activator (e.g., activator(s) 328 of FIG. 3). If a region-status-change request has been received, then process 700 may flow to block 712; otherwise, process 700 may loop to block 704 to continue to obtain signals from the microphone array.

At block 712, the status of at least one region may be modified based on the received request (e.g., employment of the activator or receipt of a trigger word/phrase). In some embodiments, the status of a region that corresponds to a change request may be modified. For example, a user's use of a trigger word in a particular region (e.g., voice recognition of a signal associated with the region may be detected) may change that particular region from inactive to active (or from active to inactive). Similarly, a user may have depressed a button (or other activator) that corresponds to the region to change its status.

In other embodiments, the status of a plurality of regions may be modified based on a change of region status request. For example, a user's use of a trigger word in a particular inactive region may change that particular region from inactive to active, and a currently active region may be changed to be inactive. In various embodiments, the currently active region may be simultaneously changed with the newly activated region or it may be delayed. In at least one embodiment, the currently active region may remain active if another trigger word is received or if the user continues to speak in that region. In another embodiment, the currently active region may remain active until a status-change request is received to inactivate the region.

After block 712, process 700 may loop to block 704 to continue to obtain signals from the microphone array.

In some embodiments, process 700 may continue until the speaker/microphone system is turned off, a phone call terminates or is disconnected, or the like.

FIG. 8 illustrates a logical flow diagram of an environment generally showing an embodiment of a process for tracking audio listening regions and providing user feedback.

Process 800 may begin, after a start block, at block 802, where active and inactive regions associated with the microphone array may be determined. In at least one of various embodiments, block 802 may employ embodiments of block 702 of FIG. 7.

Process 800 may proceed to block 804, where signals from the microphone array may be obtained for each different region. In various embodiments, block 804 may employ embodiments of block 704 of FIG. 7.

Each region may be separately processed, where process 800 may flow from block 804 to block 806 for each active region, and where process 800 may flow from block 804 to block 816 for each inactive region.

At block 806, an active-region indicator may be provided to a user. As described herein, each region may have a corresponding indicator (e.g., indicator(s) 326 of FIG. 3). In some embodiments, an active-region indicator may be a green LED, display screen indicating an active region, or the like.

Process 800 may proceed to block 808 for each active region, where an indicator of each active region's signal quality may be provided to a user. In various embodiments, this indicator may represent an SNR of the signal associated with the active region. As described herein, one or more thresholds of signal quality may be employed with one or more different indicators indicating the different bands between thresholds. For example, and good quality signal (or SNR above a first threshold) may be a green LED, an acceptable quality signal (or SNR below the first threshold but above a second threshold) may be a yellow LED, a poor quality signal (or SNR below the second threshold but above a third threshold) may be an orange LED, and a bad quality signal (or SNR below the third threshold) may be a blue LED. It should be recognized that other colors, types of indicators, numbers of indicators, or other visual indicators may also be employed to indicate a current signal quality of an active region to a user. For example, in some embodiments, the indicator may be a display that may include words regarding the signal quality and/or may provide instructions to the user for user actions that may improve the signal quality (e.g., move closer to the speaker/microphone system).

Process 800 may continue to block 810 for each active region, where speech enhancement algorithms and/or mechanisms may be employed on the signal(s) associated with the active regions. In various embodiments, block 810 may employ embodiments of bloc 708 to enhance active region signals.

Process 800 may proceed next to decision block 812 for each active region, where a determination may be made whether an inactivation trigger has been received. In various embodiments, a user may employ an activator (e.g., activator(s) 328 of FIG. 3), which may be a trigger to inactivate a currently active region. For example, a user may depress a button (which may be a physical button or may be a graphical button on a display screen) that corresponds to a region to inactivate the region. In other embodiments, a user may depress a button on another region that is currently inactive (e.g., as described at decision block 822), where activation of the other region triggers the currently active region to become inactive. As described herein, Various triggers may be employed to initiate inactivation of a region.

If an inactivation trigger is received, process 800 may flow to block 814 to inactivate the region; otherwise, process 800 may loop to block 804 to obtain additional signals from the microphone array.

After active regions are inactivated at block 814, process 800 may loop to block 804 to continue to obtain signals from the microphone array.

For each inactive region, process 800 may flow from block 804 to block 816. At block 816, an inactive region indicator may be provided to the user. Similar to block 806 (but for the indicator being for an inactive region rather than an active region), an inactive-region indicator may be a red LED, display screen indicating an inactive region, or the like.

Process 800 may proceed to block 818 for each inactive region, where noise reduction may be performed on signals associated with the inactive regions. In various embodiments, block 818 may employ embodiments of block 706 of FIG. 7.

Process 800 may continue at block 820 for each inactive region, where the signals associated with the inactive regions may be scanned for an activation trigger. In various embodiments, each signal associated with an inactive region may be processed by voice and/or speech recognition methods to detect trigger words and/or phrases. In various embodiments, the activation trigger may be a single word, such as “cowboy,” or may be a plurality of words or a phrase, such as “let me speak.” Embodiments, however, are not limited to a specific word and/or phrase as an activation trigger. For example, in some embodiments, the speaker/microphone system may be programmable such that a user can select and/or record a specific word or phrase to be used as a trigger. In some embodiments, one trigger word may be used to activate an inactive region, while a different trigger word may be used to inactivate an active region (e.g., as determined and executed at blocks 812 and 814). Similarly, one trigger word may be used to activate an inactive region and simultaneous inactive each other active region, while a different trigger word may be used to active an inactive region independent of the status of each other region.

Process 800 may proceed next to decision block 822 for each inactive region, where a determination may be made whether an activation trigger has been received. In some embodiments, the activation trigger may be a word or phrase that is detected at block 820 in a signal associated with an inactive region. In other embodiments, the activation trigger may also be employment of a button or other physical activator (similar to decision block 812 (but where the resulting action is to active one or more regions, rather than inactive one or more regions).

If an activation trigger is received, then process 800 may flow to block 824 to activate the region; otherwise, process 800 may loop to block 804 to obtain addition signals from the microphone array.

After inactive regions are activated at block 824, process 800 may loop to block 804 to continue to obtain signals from the microphone array.

It should be understood that the embodiments described in the various flowcharts may be executed in parallel, in series, or a combination thereof, unless the context clearly dictates otherwise. Accordingly, one or more blocks or combinations of blocks in the various flowcharts may be performed concurrently with other blocks or combinations of blocks. Additionally, one or more blocks or combinations of blocks may be performed in a sequence that varies from the sequence illustrated in the flowcharts.

Further, the embodiments described herein and shown in the various flowcharts may be implemented as entirely hardware embodiments (e.g., special-purpose hardware), entirely software embodiments (e.g., processor-readable instructions), user-aided, or a combination thereof. In some embodiments, software embodiments can include multiple processes or threads, launched statically or dynamically as needed, or the like.

The embodiments described herein and shown in the various flowcharts may be implemented by computer instructions (or processor-readable instructions). These computer instructions may be provided to one or more processors to produce a machine, such that execution of the instructions on the processor causes a series of operational steps to be performed to create a means for implementing the embodiments described herein and/or shown in the flowcharts. In some embodiments, these computer instructions may be stored on machine-readable storage media, such as processor-readable non-transitory storage media.

The above specification, examples, and data provide a complete description of the manufacture and use of the composition of the invention. Since many embodiments of the invention can be made without departing, from the spirit and scope of the invention, the invention resides in the claims hereinafter appended.

What is claimed is:

1. A method for providing directional speech enhancement and noise reduction, comprising:
employing each of a plurality of microphones to generate at least one audio signal based on sound sensed in a physical space, wherein the plurality of microphones are arranged to logically define the physical space into a plurality of listening regions, and wherein each status for each listening region is logically defined as active or inactive;
generating an output signal from the audio signals, wherein directional noise reduction is performed on each audio signal associated with each inactive listening region and speech enhancement is performed on each audio signal associated with each active listening region;
modifying a current status of at least one of the plurality of listening regions based on a request to change the current status to its opposite status; and
providing an indication to a user regarding each current status for each of the plurality of listening regions.

2. The method of claim 1, further comprising providing another indication to the user regarding a quality of the audio signals associated with each active listening region.

3. The method of claim 1, further comprising monitoring at least the audio signals associated with each inactive listening region for a spoken word that is operative to trigger the request to change the current status.

4. The method of claim 1, wherein the request is triggered by an action from the user on at least one of a plurality of activators, wherein each activator corresponds to at least one different listening region.

5. The method of claim 1, wherein modifying the current status further comprises triggering modification of a current status of at least one other listening region to its opposite status.

6. The method of claim 1, further comprising providing a user interface to the user, which includes an activator and an indicator for each of the plurality of listening regions, wherein each activator enables the user to activate or inactivate the current status for at least a corresponding listening region and each indicator represents an audio signal quality associated with each active listening region.

7. The method of claim 1, further comprising monitoring at least the audio signals associated with each inactive listening region for a spoken word that triggers the request, wherein a first monitored spoken word triggers activation of an inactive listening region and simultaneously triggers inactivation of an active listening region, and wherein a second monitored spoken word triggers activation of the inactive listening region and the current status of each other listening region remains unchanged.

8. An apparatus for providing directional speech enhancement and noise reduction, comprising:
a transceiver that is operative to communicate and enable phone call support with a remote computer;
a speaker that is operative to produce audio from the communication with the remote computer;
a microphone array that is operative to generate at least one audio signal based on sound sensed in a physical space, wherein the microphone array is arranged to logically define the physical space into a plurality of listening regions, and wherein each status for each listening region is logically defined as active or inactive;
a processor that is operative to execute instructions that enable actions, including:
generating an output signal from the audio signals, wherein directional noise reduction is performed on each audio signal associated with each inactive listening region and speech enhancement is performed on each audio signal associated with each active listening region; and
modifying a current status of at least one of the plurality of listening regions based on a request to change the current status to its opposite status; and
at least one indicator that is operative to provide an indication to a user regarding each current status for each of the plurality of listening regions.

9. The apparatus of claim 8, further comprising at least one other indicator that is operative to provide another indication to the user regarding a quality of the audio signals associated with each active listening region.

10. The apparatus of claim 8, wherein the processor is operative to execute instructions that enable further actions, including monitoring at least the audio signals associated with each inactive listening region for a spoken word that is operative to trigger the request to change the current status.

11. The apparatus of claim 8, further comprising a plurality of activators, wherein each activator corresponds to at least one different listening region, and wherein the request is triggered by an action from the user on at least one of the plurality of activators.

12. The apparatus of claim 8, wherein modifying the current status further comprises triggering modification of a current status of at least one other listening region to its opposite status.

13. The apparatus of claim 8, further comprising a display screen that is operative to provide a user interface to the user, which includes an activator and an indicator for each of the plurality of listening regions, wherein each activator enables the user to activate or inactivate the current status for at least a corresponding listening region and each indicator represents an audio signal quality associated with each active listening region.

14. The apparatus of claim 8, wherein the processor is operative to execute instructions that enable further actions, including monitoring at least the audio signals associated with each inactive listening region for a spoken word that triggers the request, wherein a first monitored spoken word triggers activation of an inactive listening region and simultaneously triggers inactivation of an active listening region, and wherein a second monitored spoken word triggers activation of the inactive listening region and the current status of each other listening region remains unchanged.

15. A hardware chip that is operative to provide directional speech enhancement and noise reduction for a speaker and microphone system, comprising:
an input logic that is operative to employ each of a plurality of microphones to generate at least one audio signal based on sound sensed in a physical space, wherein the plurality of microphones are arranged to logically define the physical space into a plurality of listening regions, and wherein each status for each listening region is logically defined as active or inactive;
a speech enhancer logic that is operative to generate an output signal from the audio signals, wherein directional noise reduction is performed on each audio signal associated with each inactive listening region and speech enhancement is performed on each audio signal associated with each active listening region;
a trigger monitor logic that is operative to modify a current status of at least one of the plurality of listening regions based on a request to change the current status to its opposite status; and
a display indicator logic that is operative to provide an indication to a user regarding each current status for each of the plurality of listening regions.

16. The hardware chip of claim 15, wherein the display indicator logic is further operative to provide another indication to the user regarding a quality of the audio signals associated with each active listening region.

17. The hardware chip of claim 15, wherein the trigger monitor logic is further operative to monitor at least the audio signals associated with each inactive listening region for a spoken word that is operative to trigger the request to change the current status.

18. The hardware chip of claim 15, wherein the request is triggered by an action from the user on at least one of a plurality of activators, wherein each activator corresponds to at least one different listening region.

19. The hardware chip of claim 15, wherein the display indicator logic is further operative to provide a user interface to the user, which includes an activator and an indicator for each of the plurality of listening regions, wherein each activator enables the user to activate or inactivate the current status for at least a corresponding listening region and each indicator represents an audio signal quality associated with each active listening region.

20. The hardware chip of claim 15, wherein the trigger monitor logic is further operative to monitor at least the audio signals associated with each inactive listening region for a spoken word that triggers the request, wherein a first monitored spoken word triggers activation of an inactive listening region and simultaneously triggers inactivation of an active listening region, and wherein a second monitored spoken word triggers activation of the inactive listening region and the current status of each other listening region remains unchanged.
